(19) United States
(12) Patent Application Publication
(10) Pub. No.: US 2026/0282078 A1
(43) Pub. Date: Sep. 17, 2026

(54) TERMINAL DEVICE AND METHOD FOR SIDELINK COMMUNICATION

(71) Applicant: LENOVO (BEIJING) LIMITED, Beijing (CN)

(72) Inventors: Jing HAN, Beijing (CN); Ran YUE, Beijing (CN); Haiming WANG, Beijing (CN); Lianhai WU, Beijing (CN); Jie HU, Beijing (CN)

(21) Appl. No.: 19/157,103

(22) PCT Filed: Feb. 17, 2023
(86) PCT No.: PCT/CN2023/076836

§ 371 Date: Aug. 15, 2025

(51) Int. Cl. H04W 74/0808; H04W 92/18

(52) U.S. Cl. CPC H04W 74/0808; H04W 92/18

(57) ABSTRACT

Embodiments of the present disclosure relate to a terminal device and a method for sidelink communication. A terminal device determines a consistent listen-before-talk (LBT) failure associated with a resource set for sidelink transmissions on unlicensed band. The terminal device performs a consistent LBT failure recovery in response to the consistent LBT failure being determined on the resource set. In this way, the sidelink transmission associated with the terminal device can coexist with other transmissions based on other wireless technologies, for example, on unlicensed band.

### FIELD

Embodiments of the present disclosure generally relate to the field of communication, and in particular to a terminal device, a method, and a non-transitory computer readable medium for sidelink communication.

### BACKGROUND

The New Radio (NR) operation on unlicensed bands relies on the user equipment (UE) sensing the radio resources before commencing transmission. This technique is known as Listen-Before-Talk (LBT). In NR on Unlicensed band (NR-U), to co-exist with other wireless technology on unlicensed band e.g. Wi-Fi system, a LBT procedure may be performed before each transmission to occupy the channel. If LBT is failed, which means the channel is already occupied, corresponding transmission will be dropped and a LBT failure indication is sent to the media access control (MAC) layer from lower layers. Then MAC layer will count the number of LBT failure indication in timer period, and trigger consistent LBT failure if a condition is fulfilled.

The sidelink (SL) transmission may also operate on unlicensed bands. The LBT mechanism in NR-U may be introduced for the SL transmission to co-exist with other wireless systems on the unlicensed bands. Enhancements on SL on Unlicensed band (SL-U) are still needed.

### SUMMARY

In general, embodiments of the present disclosure provide a solution for supporting a LBT mechanism for sidelink transmissions.

In a first aspect, there is provided a terminal device. The terminal device comprises a processor and a transceiver coupled to the processor. The processor is configured to determine, via the transceiver, a consistent listen-before-talk (LBT) failure associated with a resource set for sidelink transmissions on unlicensed band; and perform a consistent LBT failure recovery in response to the consistent LBT failure being determined on the resource set.

In a second aspect, there is provided a method performed by a terminal device. The method comprises determining a consistent listen-before-talk (LBT) failure associated with a resource set for sidelink transmissions on unlicensed band. The method further comprises performing a consistent LBT failure recovery in response to the consistent LBT failure being determined on the resource set.

In a third aspect, there is provided a non-transitory computer readable medium. The non-transitory computer readable medium having program instructions stored thereon. The program instructions, when executed by an apparatus, causing the apparatus at least to: determine a consistent listen-before-talk (LBT) failure associated with a resource set for sidelink transmissions on unlicensed band; and perform a consistent LBT failure recovery in response to the consistent LBT failure being determined on the resource set.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some embodiments will now be described with reference to the accompanying drawings, in which:

FIG. 1 illustrates a schematic diagram of a communication environment in which some embodiments of the present disclosure can be implemented;

FIG. 2 illustrates a flowchart of an example method for communication in accordance with some embodiments of the present disclosure; and

FIG. 3 illustrates a simplified block diagram of an apparatus that is suitable for implementing embodiments of the present disclosure.

Throughout the drawings, the same or similar reference numerals represent the same or similar elements.

### DETAILED DESCRIPTION

Principles of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein may be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an example embodiment,” “an embodiment,” “some embodiments,” and the like indicate that the embodiment(s) described may include a particular feature, structure, or characteristic, but it is not necessary that every embodiment includes the particular feature, structure, or characteristic. Moreover, such phrases do not necessarily refer to the same embodiment(s). Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” or the like may be used herein to describe various elements, these elements should not be limited by these terms. These terms are only used to distinguish one element from another element. For example, a first element could also be termed as a second element, and similarly, a second element could also be termed as a first element, without departing from the scope of embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, the term “communication network” refers to a network following any suitable communication standards, such as, 5G NR, Long Term Evolution (LTE), LTE-Advanced (LTE-A), Wideband Code Division Multiple Access (WCDMA), High-Speed Packet Access (HSPA), Narrow Band Internet of Things (NB-IoT), and so on. Further, the communications between a terminal device and a network device in the communication network may be performed according to any suitable generation communication protocols, including but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will also be future type communication technologies and systems in which the present disclosure may be embodied. It should not be seen as limiting the scope of the present disclosure to only the aforementioned systems.

As used herein, the term “network device” generally refers to a node in a communication network via which a terminal device can access the communication network and receive services therefrom. The network device may refer to a base station (BS) or an access point (AP), for example, a node B (NodeB or NB), a radio access network (RAN) node, an evolved NodeB (eNodeB or eNB), a NR NB (also referred to as a gNB), a Remote Radio Unit (RRU), a radio header (RH), an infrastructure device for a V2X (vehicle-to-everything) communication, a transmission and reception point (TRP), a reception point (RP), a remote radio head (RRH), a relay, an integrated access and backhaul (IAB) node, a low power node such as a femto BS, a pico BS, and so forth, depending on the applied terminology and technology.

As used herein, the term “terminal device” generally refers to any end device that may be capable of wireless communications. By way of example rather than a limitation, a terminal device may also be referred to as a communication device, a user equipment (UE), an end user device, a subscriber station (SS), an unmanned aerial vehicle (UAV), a portable subscriber station, a mobile station (MS), or an access terminal (AT). The terminal device may include, but is not limited to, a mobile phone, a cellular phone, a smart phone, a voice over IP (VoIP) phone, a wireless local loop phone, a tablet, a wearable terminal device, a personal digital assistant (PDA), a portable computer, a desktop computer, an image capture terminal device such as a digital camera, a gaming terminal device, a music storage and play back appliance, a vehicle-mounted wireless terminal device, a wireless endpoint, a mobile station, laptop-embedded equipment (LEE), laptop-mounted equipment (LME), a USB dongle, a smart device, wireless customer-premises equipment (CPE), an Internet of Things (IoT) device, a watch or other wearable, a head-mounted display (HMD), a vehicle, a drone, a medical device (for example, a remote surgery device), an industrial device (for example, a robot and/or other wireless devices operating in an industrial and/or an automated processing chain contexts), a consumer electronics device, a device operating on commercial and/or industrial wireless networks, and the like. In the following description, the terms: “terminal device,” “communication device,” “terminal,” “user equipment” and “UE,” may be used interchangeably.

As used herein, the term: “resource,” “transmission resource,” “resource block,” “physical resource block,” “uplink resource,” “downlink resource,” or “sidelink resource” may refer to any resource, for example a resource in time domain, a resource in frequency domain, a resource in space domain, a resource in code domain, or any other resource enabling a communication, and the like, used for performing a communication between a terminal device and a network device or between terminal devices. In the following, a resource in both frequency and time domain will be used as an example of a transmission resource for describing some embodiments of the present disclosure. It is noted that embodiments of the present disclosure equally apply to other resources in other domains.

To expand the applicability of sidelink communication to commercial use cases, one of identified key requirement is to increase the data rate. SL-U may be supported to fulfill the requirement. In addition, with the support of unlicensed spectrum, sidelink communication will be in a better position to be implemented in commercial devices since utilization of the Intelligent Transport System (ITS) band is limited to ITS safety related applications.

As mentioned above, the LBT mechanism in NRU may be introduced for the SL transmission to co-exist with other wireless systems on unlicensed band. Before each sidelink transmission, SL UE may need to perform LBT and drop the sidelink transmission if the LBT is failed. In addition, the MAC layer may count the number of LBT failure indications and trigger a consistent LBT failure if a condition is fulfilled. However, legacy schemes do not consider sidelink specific issues.

In view of the above discussions, embodiments of the present disclosure provide a solution for supporting a LBT mechanism for sidelink transmissions. In one aspect of the solution of the present disclosure, a terminal device determines a consistent listen-before-talk (LBT) failure associated with a resource set for sidelink transmissions on unlicensed band. The terminal device performs a consistent LBT failure recovery in response to the consistent LBT failure being determined on the resource set. Through the proposed solution, sidelink communications between terminal devices can coexist with other communications based on other wireless technologies, for example, on unlicensed band. Principles and implementations of embodiments of the present disclosure will be described in detail below with reference to the figures.

### Example Embodiment

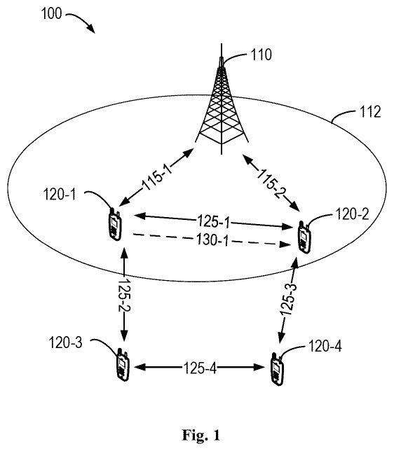

FIG. 1 illustrates a schematic diagram of a communication environment 100 in which some embodiments of the present disclosure can be implemented. As shown in FIG. 1, the communication environment 100, which may also be referred to as a communication network 100 or a communication system 100, includes a network device 110, a terminal device 120-1, a terminal device 120-2, a terminal device 120-3 and a terminal device 120-4 (collectively referred to as terminal devices 120).

The network device 110 manages a cell 112 and serves the terminal device 120-1 and the terminal device 120-2 in the cell 112. To transmit data and/or control information, the terminal device 120-1 and the terminal device 120-2 can perform communications with the network device 110, respectively. In particular, as illustrated in the exemplary scenario of FIG. 1, the terminal device 120-1 may communicate with the network device 110 via a communication link 115-1, and the terminal device 120-2 may communicate with the network device 110 via a communication channel 115-2. For transmissions from the network device 110 to the terminal device 120-1 or 120-2, the communication link 115-1 or 115-2 may be referred to as a downlink, whereas for transmissions from the terminal device 120-1 or 120-2 to the network device 110, the communication link 115-1 or 115-2 may alternatively be referred to as an uplink.

In addition to the communication links 115-1 and 115-2, the terminal device 120-1 and the terminal device 120-2 can perform a sidelink transmission, which is also referred to as a device-to-device (D2D) communication, via a sidelink 125-1 between the terminal device 120-1 and the terminal device 120-2. For example, in the exemplary scenario of FIG. 1, the terminal device 120-1 is to perform a sidelink transmission 130-1 to the terminal device 120-2 via the sidelink 125-1. In some embodiments, the sidelink transmission 130-1 may be performed on unlicensed band in which various wireless devices based on different wireless technologies share the same wireless spectrum.

As shown in FIG. 1, the terminal devices 120-3 and 120-4 may be outside of the coverage range (namely, outside of the cell 112) of the network device 110. For the terminal devices 120-3 and 120-4, only sidelink communications may exist. For example, the terminal device 120-1 and the terminal device 120-3 can perform a sidelink transmission via a sidelink 125-2 between the terminal device 120-1 and the terminal device 120-3. The terminal device 120-2 and the terminal device 120-4 can perform a sidelink transmission via a sidelink 125-3 between the terminal device 120-2 and the terminal device 120-4. The terminal device 120-3 and the terminal device 120-4 can perform a sidelink transmission via a sidelink 125-4 between the terminal device 120-3 and the terminal device 120-4. Although not shown in FIG. 1, sidelink transmissions may be performed between the terminal device 120-1 and the terminal device 120-4 and between the terminal device 120-2 and the terminal device 120-3 via respective sidelinks.

In some embodiments, the network device 110 may be absent in the communication environment 100. In other words, the terminal devices 120-1, 120-2, 120-3 and 120-4 as well as possibly other terminal devices (not shown) may be outside of the coverage range (namely, outside of the cell 112) of the network device 110. In such cases, only sidelink communications may exist between the terminal devices 120-1, 120-2, 120-3, 120-4 and possibly other terminal devices not shown in FIG. 1.

As used herein, the term “sidelink transmission” generally refers to any transmission performed from one terminal device to another terminal device. The sidelink transmission may be used for transmitting any data or control information associated with sidelink communications, for example, sidelink data, sidelink control information, sidelink feedback information, or the like. As used herein, the term “sidelink channel” may generally refer to any channel used for sidelink communications, for example, Physical Sidelink Shared Channel (PSSCH), Physical Sidelink Control Channel (PSCCH), Physical Sidelink Discovery Channel (PSDCH), Physical Sidelink Broadcast Channel (PSBCH), Physical Sidelink Feedback Channel (PSFCH), and other existing or future sidelink channels.

Channel access in the sidelink can rely on the so-called LBT procedure. For example, before performing the sidelink transmission 130-1, the terminal device 120-1 can firstly “sense” a communication channel to find out that there are no communications on the communication channel prior to any transmission on the communication channel. For example, the “channel sensing” procedure may rely on detecting the energy level on the communication channel. If LBT is failed, which means the channel is already occupied, corresponding transmission will be dropped and a LBT failure indication is sent to the upper layer of the terminal device 120-1 from a lower layer of the terminal device 120-1. The upper layer may be a MAC layer and the lower layer may be a physical layer. The MAC layer may count the number of LBT failure indications in a timer period, and trigger a consistent LBT failure if a condition is fulfilled, e.g., if the counted number exceeds a threshold. In some embodiments, the LBT parameters (such as type/duration, clear channel assessment parameters, counting rules, counting threshold and the like) may be configured in the terminal device 120-1, for example, by the network device 110. Channel access mechanisms and principles of consistent LBT failure in NR-U may be reused for SL-U operations.

Although the network device 110 and the terminal devices 120-1, 120-2, 120-3, 120-4 are described in the communication environment 100 of FIG. 1, embodiments of the present disclosure may equally apply to any other suitable communication devices in communication with one another. That is, embodiments of the present disclosure are not limited to the exemplary scenarios of FIG. 1. In this regard, it is noted that although the network device 110 is schematically depicted as a base station and the terminal devices 120 are schematically depicted as mobile phones in FIG. 1, it is understood that these depictions are exemplary in nature without suggesting any limitation. In other embodiments, the network device 110 and the terminal devices 120 may be any other communication devices, for example, any other wireless communication devices.

In case the terminal devices 120-1, 120-2, 120-3 and 120-4 are vehicle-mounted terminal devices, communication relate to them may be referred to as a V2X communication. More generally, although not shown in FIG. 1, the V2X communication related to the terminal devices 120 may comprise a communication channel between the terminal devices 120 and any other communication device, including but not limited to, an infrastructure device, another vehicle-mounted terminal device, a device of a pedestrian, a roadside unit, or the like. Furthermore, although not shown, all the communication links as shown in FIG. 1 may be via one or more relays.

It is to be understood that the particular number of various communication devices, the particular number of various communication links, the particular number of other elements, and the particular shape of the cell 112 as shown in FIG. 1 is for illustration purpose only without suggesting any limitations. The communication environment 100 may include any suitable number of communication devices, any suitable number of communication links, any suitable number of other elements and any suitable shape of the cell 112 adapted for implementing embodiments of the present disclosure. In addition, it should be appreciated that there may be various wireless as well as wireline communications (if needed) among all of the communication devices.

Communication in the communication environment 100 may be implemented according to any proper communication protocol(s), comprising but not limited to, cellular communication protocols of the first generation (1G), the second generation (2G), the third generation (3G), the fourth generation (4G) and the fifth generation (5G), NR-U and the like, wireless local network communication protocols such as Institute for Electrical and Electronics Engineers (IEEE) 802.11 and the like, and/or any other protocols currently known or to be developed in the future. Moreover, such communication may utilize any appropriate wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

### Example Method

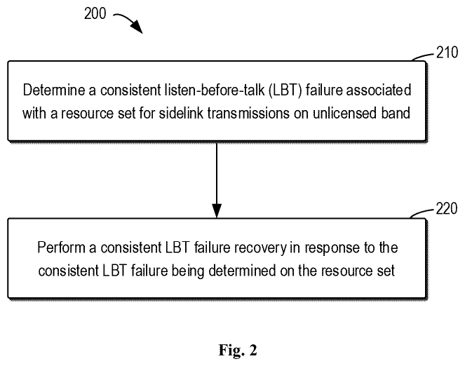

FIG. 2 illustrates a flowchart of an example method 200 for communication in accordance with some embodiments of the present disclosure. In some embodiments, the method 200 can be implemented at a device in a communication network, such as the terminal device 120-1 as shown in FIG. 1. Additionally or alternatively, the method 200 can be implemented at other devices shown in FIG. 1. In some other embodiments, the method 200 may be implemented at devices not shown in FIG. 1. Further, it is to be understood that the method 200 may include additional blocks not shown and/or may omit some blocks as shown, and the scope of the present disclosure is not limited in this regard. For the purpose of discussion, the method 200 will be described from the perspective of the terminal device 120-1 with reference to FIG. 1.

At block 210, the terminal device 120-1 determines a consistent LBT failure associated with a resource set for sidelink transmissions on unlicensed band. For example, with reference to FIG. 1, if the sidelink transmission 130-1 is to be performed in on unlicensed band, the terminal device 120-1 may firstly perform a LBT procedure for the sidelink transmission 130-1 in a resource set. At block 220, the terminal device 120-1 performs a consistent LBT failure recovery in response to the consistent LBT failure being determined on the resource set.

For example, the terminal device 120-1 may determine whether a channel for the sidelink transmission 130-1 is occupied during the LBT procedure. For example, if the terminal device 120-1 detects that the energy level on the channel is higher than or equal to a threshold energy level, then the terminal device 120-1 may determine that the channel for the sidelink transmission 130-1 is occupied. Otherwise, if the terminal device 120-1 detects that the energy level on the channel is lower than the threshold energy level, the terminal device 120-1 may determine that the channel for the sidelink transmission 130-1 is not occupied. If the terminal device 120-1 determines that the channel for the sidelink transmission 130-1 is occupied during the LBT procedure, the terminal device 120-1 may generate a LBT failure indication.

It may be assumed that the lower layer (e.g., a physical layer) of the terminal device 120-1 performs the LBT procedure, according to which the sidelink transmission 130-1 is not performed by the lower layer if the channel is identified as being occupied. If the lower layer performs the LBT procedure before the sidelink transmission 130-1 and determines the channel is occupied according to LBT results, a LBT failure indication may be sent to the MAC layer of the terminal device 120-1 from the lower layer. The MAC layer may count the number of LBT failure indications received from the lower layer. If the counted number goes beyond a threshold during a monitoring period or window, a consistent LBT failure may be determined. The monitoring period or window may be started or restarted based on a device decision or triggered by the network device 110. The duration of the monitoring window may be based on a network configuration, a resource specific configuration or the device decision.

In some embodiments, the LBT procedure for the sidelink transmission 130-1 may be largely similar to the LBT procedures for the downlink and uplink transmissions on unlicensed band. However, since the characteristic of a sidelink transmission may be different from that of a downlink or uplink transmission, there may be some differences between the LBT procedure for a sidelink transmission in accordance with embodiments of the present disclosure and the conventional LBT procedures for the downlink and uplink transmissions. For example, different with the conventional LBT procedures in NRU, the granularity of consistent LBT failure in SLU e.g. resource pool based or RB set based, needs to be handled specifically. Furthermore, PSFCH transmission and PSBCH transmission need to be considered. Such differences will be further detailed hereinafter.

As can be seen from embodiments described with reference to FIG. 2, a method of consistent LBT failure for sidelink unlicensed transmission is proposed. The method 200 can be used by the terminal device 120-1 to determine and recover from consistent SL LBT failures. Through the solution of the present disclosure, a mechanism for handling with LBT failures for SL-U is provided. Sidelink communications between terminal devices can coexist with other communications based on other wireless technologies, for example, on unlicensed band.

Hereinbefore, some embodiments of the LBT mechanism for sidelink transmissions are described in general terms. Some more embodiments of the LBT mechanism for sidelink transmissions will be further detailed in regard to various specific aspects.

The first specific aspect of the LBT mechanism for sidelink transmissions is the resource granularity of the consistent LBT failure. For the sidelink transmissions, possible resource granularities may be, for example, per sidelink bandwidth part (SL-BWP), per resource pool or per resource block (RB) set. As used herein, the term “resource set” refers to resources with a size associated with the resource granularity of the consistent LBT failure. In some embodiments, the LBT procedure may be performed on the resource set. If the LBT is failed, the LBT failure indications may comprise an indication of the associated resource set. The terminal device 120-1 may count the number of LBT failure indications associated with the resource set.

In general, a resource pool for sidelink transmissions can be considered as a set of transmission resources that can be used by a terminal device 120-1 to perform a sidelink transmission. When communicating on a sidelink, the terminal device 120-1 may use resources selected from the resource pool. The resource pool may be defined as a consecutive number of resource blocks (RBs) in the frequency domain in units of sub-channels. In other words, a resource pool may be composed of a plurality of consecutive RBs in frequency. In particular, a sub-channel may be defined as one or more of the RBs (e.g., that are consecutive), and a resource pool may be defined as one or more sub-channels. The LBT operation may be performed on a LBT subband basis. One LBT subband may include one or more RBs. The LBT subband may be referred to as ‘RB set’ or ‘LBT bandwidth’.

In some embodiments, resource granularity for sidelink transmissions may be per SL-BWP and the resource set may comprise at least one SL-BWP. The terminal device 120-1 may count the number of LBT failure indications per SL-BWP. In other words, the number of LBT failure indications may be counted separately for individual BWPs. For example, the terminal device 120-1 may be configured with at least one SL-BWP for performing the sidelink transmission 130-1. In some embodiments, the LBT failure indication for a sidelink transmission may comprise an indication of the SL-BWP on which the LBT is performed. The MAC layer of the terminal device 120-1 may count the number of LBT failure indications associated with the at least one SL-BWP. If the counted number of LBT failure indications associated with the at least one SL-BWP exceeds a threshold, a consistent LBT failure may be determined on the at least one SL-BWP.

Alternatively, resource granularity for sidelink transmissions may be per resource pool and the resource set may comprise at least one resource pool. The terminal device 120-1 may count the number of LBT failure indications per resource pool. In other words, the number of LBT failure indications may be counted separately for individual resource pools. For example, the terminal device 120-1 may be configured with at least one resource pools for performing the sidelink transmission 130-1. In some embodiments, the LBT failure indication for a sidelink transmission may comprise an indication of the resource pool on which the LBT is performed. The MAC layer of the terminal device 120-1 may count the number of LBT failure indications associated with the at least one resource pool. If the counted number of LBT failure indications associated with the at least one resource pool exceeds a threshold, a consistent LBT failure may be determined on the at least one resource pool.

Alternatively, resource granularity for sidelink transmissions may be per RB set and the resource set may comprise at least one RB set. The terminal device 120-1 may count the number of LBT failure indications per RB set. In other words, the number of LBT failure indications may be counted separately for individual BWPs. For example, the terminal device 120-1 may be configured with at least one RB set for performing the sidelink transmission 130-1. In some embodiments, the LBT failure indication for a sidelink transmission may comprise an indication of the RB set on which the LBT is performed. The MAC layer of the terminal device 120-1 may count the number of LBT failure indications associated with the at least one RB set. If the counted number of LBT failure indications associated with the at least one RB set exceeds a threshold, a consistent LBT failure may be determined on the at least one RB set.

The second specific aspect of the LBT mechanism for sidelink transmissions is the actions of a terminal device 120-1 responsive to detected LBT failures for different types of sidelink transmissions (e.g., PSFCH and PSBCH transmissions) in SL-U. In some embodiments, LBT for PSFCH transmission might be based on a different LBT type with the PSSCH/PSCCH transmissions. In addition, multiple PSFCH transmissions might be enabled for a specific sidelink transmission.

In some embodiments, only a single PSFCH transmission may be enabled for a sidelink transmission from another terminal device (e.g., the terminal device 120-2). In other words, the terminal device 120-1 may only transmit a single PSFCH transmission to the terminal device 120-2 when receiving a PSCCH/PSSCH transmission from the terminal device 120-2. Alternatively, multiple PSFCH transmissions may be enabled for a sidelink transmission from another terminal device (e.g., the terminal device 120-2). The multiple PSFCH transmissions or the single PSFCH transmission may be indicated or enabled by the network device 110 or by another terminal device.

For example, the terminal device 120-1 may be configured with multiple (e.g., 3) PSFCH opportunities for a sidelink transmission. When receiving a PSCCH/PSSCH transmission from the terminal device 120-2, the terminal device 120-1 would try to transmit a first PSFCH transmission to the terminal device 120-2 so as to provide a HARQ feedback for the PSCCH/PSSCH transmission. In order to transmit the first PSFCH transmission in SL-U, a LBT procedure may be performed firstly to occupy the channel. If LBT is failed, the first PSFCH transmission would be dropped. In such event, the terminal device 120-1 would try to transmit a second PSFCH transmission to the terminal device 120-2 so as to provide the HARQ feedback for the PSCCH/PSSCH transmission. If LBT for the second PSFCH transmission is failed, the terminal device 120-1 would try to transmit a third PSFCH transmission to the terminal device 120-2 so as to provide the HARQ feedback for the PSCCH/PSSCH transmission. With very high probability, the terminal device 120-1 may complete the HARQ feedback transmission successfully before maximal number of PSFCH transmissions is achieved. For example, if the LBT for the first PSFCH transmission succeeds, the terminal device 120-1 may occupy the channel and transmit the first PSFCH transmission and may omit the second and third PSFCH transmissions. If the LBT for the second PSFCH transmission succeeds, the terminal device 120-1 may occupy the channel and transmit the second PSFCH transmission and may omit the third PSFCH transmission. The first, second and third PSFCH transmissions may provide the same HARQ feedback for the same PSCCH/PSSCH transmission.

Moreover, additional PSBCH transmissions might be transmitted on the resource pool. A possible case where the PSBCH transmission happens on the same RB set with PSSCH/PSCCH/PSFCH transmissions also needs to be considered. UE actions need to be designed responsive to detected LBT failures for sidelink transmissions in SL-U.

As mentioned above, the sidelink transmissions may refer to any transmission performed between terminal devices, including PSSCH transmissions, PSCCH transmissions, PSDCH transmissions, PSBCH transmissions, PSFCH, and transmissions on other existing or future sidelink channels. As used herein, the term “PSBCH transmissions” can be used interchangeably with “sidelink synchronization signal block (S-SSB) transmissions”. In some embodiments, the terminal device 120-1 may count the number of LBT failures for any sidelink transmissions on the resource set and determine a consistent LBT failure on the resource set if the counted number exceeds a threshold. Alternatively, the terminal device 120-1 may count the number of LBT failures for some sidelink transmissions on the resource set and determine a consistent LBT failure on the resource set. In other words, only some sidelink transmissions may be considered by the terminal device 120-1 when determining the consistent LBT failure. For example, the terminal device 120-1 may “filter out” (i.e., not consider) other sidelink transmissions and would not count the number of LBT failures even if a LBT failure is detected for these sidelink transmissions. In other words, these sidelink transmissions would not be considered by the terminal device 120-1 when determining the consistent LBT failure. Hereinafter, the term “a first set of sidelink transmissions” may be used to refer to the sidelink transmissions considered by the terminal device 120-1 when determining the consistent LBT failure. Embodiments of the first set of sidelink transmissions will be described in detail below.

In some embodiments, the terminal device 120-1 may apply a lower layer filtering mechanism when determining the consistent LBT failure responsive to detected LBT failures. If a lower layer of the terminal device 120-1 detects a LBT failure for a sidelink transmission on the resource set, the lower layer may determine whether the sidelink transmission associated with the detected LBT failure is among the sidelink transmissions associated with the determination of the consistent LBT failure. If the sidelink transmission associated with the detected LBT failure is among the sidelink transmissions associated with the determination of the consistent LBT failure, the lower layer may transmit a LBT failure indication associated with the resource set to the upper layer (e.g., MAC layer) and the MAC layer may thus increment the number of LBT failure indications. In other words, the lower layer may determine whether the sidelink transmission associated with the detected LBT failure belongs to the first set of sidelink transmissions. If the sidelink transmission associated with the detected LBT failure belongs to the first set of sidelink transmissions, indicating this sidelink transmission should be considered by the terminal device 120-1 when determining the consistent LBT failure, the lower layer may thus transmit a LBT failure indication to the MAC layer. If the sidelink transmission associated with the detected LBT failure does not belong to the first set of sidelink transmissions, indicating this sidelink transmission should not be considered by the terminal device 120-1 when determining the consistent LBT failure, the lower layer would not transmit a LBT failure indication to the MAC layer.

In some embodiments, the terminal device 120-1 may apply an upper layer (e.g., MAC layer) filtering mechanism when determining the consistent LBT failure responsive to detected LBT failures. If a LBT failure for a sidelink transmission on the resource set is detected by the lower layer of the terminal device 120-1, the lower layer may send a LBT failure indication to the MAC layer of the terminal device. If the sidelink transmission associated with the LBT failure indication is among the sidelink transmissions associated with the determination of the consistent LBT failure, the MAC layer may increment the number of LBT failure indications. In other words, the MAC layer may determine whether the sidelink transmission associated with the received LBT failure indication belongs to the first set of sidelink transmissions. If the sidelink transmission associated with the received LBT failure indication belongs to the first set of sidelink transmissions, indicating this sidelink transmission should be considered by the terminal device 120-1 when determining the consistent LBT failure, the MAC layer may thus increment the number of LBT failure indications. If the sidelink transmission associated with the received LBT failure indication does not belong to the first set of sidelink transmissions, indicating this sidelink transmission should not be considered by the terminal device 120-1 when determining the consistent LBT failure, the MAC layer would not increment the number of LBT failure indications.

In some embodiments, the first set of sidelink transmissions may comprise PSCCH transmissions. For example, when determining the consistent LBT failure, the terminal device 120-1 may only consider the detected LBT failures for PSCCH transmissions on the resource set. The upper layer (e.g., MAC layer) filtering mechanism or the lower layer filtering mechanism for determination of the consistent LBT failure may be applied by filtering out sidelink transmissions other than PSCCH transmissions. In one example, if a SL LBT failure indication for PSCCH transmission on the resource set is received from the lower layer, the MAC layer of the terminal device 120-1 may perform the consistent LBT failure procedure for the resource set, e.g., increment the number of LBT failure indications associated with the resource set and determine a consistent LBT failure if the counted number exceeds a threshold. In another example, the lower layer may only indicate LBT failures for PSCCH transmissions and the MAC layer may determine the consistent LBT failure based on all LBT failure indications from the lower layer. For example, in lower layer, if the terminal device 120-1 fails to access the channel prior to an intended PSCCH transmission to a peer sidelink UE (e.g., the terminal device 120-2), Layer 1 may notify the MAC layer about the channel access failure and corresponding resource set.

In some embodiments, the first set of sidelink transmissions may comprise PSSCH transmissions. For example, when determining the consistent LBT failure, the terminal device 120-1 may only consider the detected LBT failures for PSSCH transmissions on the resource set. The upper layer (e.g., MAC layer) filtering mechanism or the lower layer filtering mechanism for determination of the consistent LBT failure may be applied by filtering out sidelink transmissions other than PSSCH transmissions.

In some embodiments, the first set of sidelink transmissions may comprise PSCCH transmissions and PSSCH transmissions. For example, when determining the consistent LBT failure, the terminal device 120-1 may only consider the detected LBT failures for PSCCH transmissions and PSSCH transmissions on the resource set. The upper layer (e.g., MAC layer) filtering mechanism or the lower layer filtering mechanism for determination of the consistent LBT failure may be applied by filtering out sidelink transmissions other than PSSCH transmissions and PSSCH transmissions. In other words, the LBT failures for PSFCH transmissions may be excluded in the consistent LBT failure detection.

In some embodiments, in addition to the PSCCH transmissions and/or PSSCH transmissions, the first set of sidelink transmissions may further comprise PSFCH transmissions. For example, when determining the consistent LBT failure, the terminal device 120-1 may consider the detected LBT failures for PSCCH transmissions, PSSCH transmissions and PSFCH transmissions on the resource set. The upper layer (e.g., MAC layer) filtering mechanism or the lower layer filtering mechanism for determination of the consistent LBT failure may be applied by filtering out other sidelink transmissions. In one example, if a SL LBT failure indication for PSCCH/PSSCH/PSFCH transmission on the resource set is received from the lower layer, the MAC layer of the terminal device 120-1 may perform the consistent LBT failure procedure for the resource set. In another example, the lower layer may only indicate LBT failures for PSCCH/PSSCH/PSFCH transmissions and the MAC layer may determine the consistent LBT failure based on all LBT failure indications from the lower layer. For example, in lower layer, if the terminal device 120-1 fails to access the channel prior to an intended PSCCH/PSSCH/PSFCH transmission to a peer sidelink UE (e.g., the terminal device 120-2), Layer 1 may notify the MAC layer about the channel access failure and corresponding resource set. In other words, the LBT failures for PSFCH transmissions may be included in the consistent LBT failure detection.

In some embodiments, in addition to the PSCCH transmissions and/or PSSCH transmissions, the first set of sidelink transmissions may further comprise PSFCH transmissions based on a specific LBT type for channel access. For example, when determining the consistent LBT failure, in addition to the detected LBT failures for PSCCH transmissions and PSSCH transmissions on the resource set, the terminal device 120-1 may consider the LBT failures detected using LBT type 1 for channel access for PSFCH transmissions on the resource set. In other words, if a LBT procedure is performed before a PSFCH transmission using LBT type 1 for channel access, the detected SL-LBT failure for PSFCH transmission may be included in the consistent LBT failure detection. If a LBT procedure is performed before a PSFCH transmission using a LBT type other than LBT type 1 for channel access, the detected SL-LBT failure for PSFCH transmission may be excluded from the consistent LBT failure detection.

In some embodiments, in addition to the PSCCH transmissions and/or PSSCH transmissions, the first set of sidelink transmissions may further comprise PSFCH transmissions in the event that a single PSFCH transmission for a sidelink transmission from another terminal device is enabled. For example, when determining the consistent LBT failure, in addition to the detected LBT failures for PSCCH transmissions and PSSCH transmissions on the resource set, the terminal device 120-1 may consider the LBT failures for PSFCH transmissions on the resource set if a single PSFCH transmission for a sidelink transmission from another terminal device is enabled. In other words, if multiple PSFCH transmission are disabled for a sidelink transmission from another terminal device, the detected SL-LBT failure for PSFCH transmission may be included in the consistent LBT failure detection. If multiple PSFCH transmissions are enabled for a sidelink transmission from another terminal device, the detected SL-LBT failure for PSFCH transmission may be excluded from the consistent LBT failure detection. In some embodiments, the multiple PSFCH transmissions may be enabled or disabled by RRC signaling. Alternatively or additionally, the multiple PSFCH transmissions or the single PSFCH transmission may be indicated by sidelink control information (SCI).

In some embodiments, if multiple PSFCH transmissions for a sidelink transmission from another terminal device are enabled, in addition to the PSCCH transmissions and/or PSSCH transmissions, the first set of sidelink transmissions may further comprise a last PSFCH transmission among the multiple PSFCH transmissions. In other words, if multiple PSFCH transmissions for are enabled (either enabled by RRC or indicated in SCI), SL-LBT failures for PSSCH and/or PSCCH transmissions and for a last PSFCH transmission among the multiple PSFCH transmissions may be included in a consistent LBT failure detection. The upper layer (e.g., MAC layer) filtering mechanism or the lower layer filtering mechanism for determination of the consistent LBT failure may be applied by filtering out other sidelink transmissions. In one example, when multiple PSFCH transmissions for a sidelink transmission from another terminal device are enabled, if a SL LBT failure indication for a last PSFCH transmission among the multiple PSFCH transmissions is received from the lower layer, the MAC layer of the terminal device 120-1 may increment the number of LBT failure indications by one. In another example, the lower layer may only indicate a LBT failure for the last PSFCH transmission among the multiple PSFCH transmissions and the MAC layer may determine the consistent LBT failure based on all LBT failure indications from the lower layer. For example, in lower layer, if the terminal device 120-1 fails to access the channel prior to a last intended PSFCH transmission among a plurality of intended PSFCH transmissions to a peer sidelink UE (e.g., the terminal device 120-2), Layer 1 may notify the MAC layer about a single channel access failure and corresponding resource set.

In some embodiments, if multiple PSFCH transmissions for a sidelink transmission from another terminal device are enabled, in addition to the PSCCH transmissions and/or PSSCH transmissions, a SL-LBT failure for PSFCH transmission may be included in a consistent LBT failure detection when LBT failures are detected for all of the multiple PSFCH transmissions. The upper layer (e.g., MAC layer) filtering mechanism or the lower layer filtering mechanism for determination of the consistent LBT failure may be applied by filtering out other sidelink transmissions. In one example, when multiple PSFCH transmissions for a sidelink transmission from another terminal device are enabled, if multiple SL LBT failure indications for the multiple PSFCH transmissions are received from the lower layer, the MAC upper layer of the terminal device 120-1 may increment the number of LBT failure indications by one. In another example, the lower layer may only indicate one LBT failure when the lower layer detects multiple SL LBT failures for the multiple PSFCH transmissions and the MAC layer may determine the consistent LBT failure based on all LBT failure indications from the lower layer. For example, if multiple PFSCH transmissions are enabled, when SL LBT failure happens for all PSFCHs, e.g., when all PSFCH opportunity has LBT failure the lower layer may notify the MAC layer about a single channel access failure and corresponding resource set.

In some embodiments, in addition to the PSCCH transmissions and/or PSSCH transmissions, the first set of sidelink transmissions may further comprise PSBCH transmissions. For example, when determining the consistent LBT failure, the terminal device 120-1 may consider the detected LBT failures for PSCCH transmissions, PSSCH transmissions and PSBCH transmissions on the resource set. The upper layer (e.g., MAC layer) filtering mechanism or the lower layer filtering mechanism for determination of the consistent LBT failure may be applied by filtering out other sidelink transmissions.

In some embodiments, in addition to the PSCCH transmissions and/or PSSCH transmissions, the first set of sidelink transmissions may further comprise PSBCH transmissions and PSFCH transmissions. For example, when determining the consistent LBT failure, the terminal device 120-1 may consider the detected LBT failures for PSCCH transmissions, PSSCH transmissions, PSBCH transmissions and PSFCH transmissions on the resource set. The upper layer (e.g., MAC layer) filtering mechanism or the lower layer filtering mechanism for determination of the consistent LBT failure may be applied by filtering out other sidelink transmissions.

In some embodiments, the first set of sidelink transmissions may comprise any sidelink transmissions, including PSSCH transmissions, PSCCH transmissions, PSDCH transmissions, PSBCH transmissions, PSFCH, and transmissions on other existing or future sidelink channels. In one example, if a SL LBT failure indication for any sidelink transmission (PSSCH/PSCCH/PSFCH/PSBCH or any other sidelink transmission) on the resource set is received from the lower layer, the terminal device 120-1 may perform the consistent LBT failure procedure. On the other hand, the lower layer may indicate LBT failures for any sidelink transmission (PSSCH/PSCCH/PSFCH/PSBCH or any other sidelink transmission) and the upper layer may determine the consistent LBT failure based on all LBT failure indications from the lower layer. For example, in lower layer, if the terminal device 120-1 fails to access the channel prior to an intended sidelink transmission (PSSCH/PSCCH/PSFCH/PSBCH or any other sidelink transmission) to a peer sidelink UE (e.g., the terminal device 120-2), Layer 1 may notify the upper layer about the channel access failure and corresponding resource set.

In some embodiments, the first set of sidelink transmissions may comprise any sidelink transmissions based on a specific LBT type for channel access. In other words, the terminal device 120-1 may determine the consistent LBT failures by considering LBT failures for any sidelink transmission in the resource set with a specific LBT type. The upper layer filtering mechanism or the lower layer filtering mechanism for determination of the consistent LBT failure may be applied by filtering out other sidelink transmissions.

The third specific aspect of the LBT mechanism for sidelink transmissions is the actions of a terminal device for the determination and recovery of consistent LBT failure for PSBCH transmissions in SL-U. For example, the terminal device 120-1 may perform a PSBCH transmission on unlicensed band. Prior to the transmission, the terminal device 120-1 may perform channel access procedure to occupy the channel, and then a PSBCH transmission may be performed. If the channel access is failed, the lower layer (e.g., physical layer) would indicate the channel access failure information (e.g., LBT failure) to upper layer (e.g., MAC layer) for PSBCH and associated resources (e.g., RB set). MAC layer may determine whether the terminal device 120-1 is experiencing a consistent LBT failure for the PSBCH on the RB set based on the LBT failure indication from lower layer. If the consistent LBT failure for the PSBCH on the RB set is determined, the terminal device 120-1 may need to recover from the detected consistent LBT failure of PSBCH on the RB set. In addition, legacy PSBCH transmissions (i.e., R16/17 PSBCH transmissions) are not transmitted in the resource pool. UE actions need to be designed responsive to the detected LBT failure for PSBCH transmissions in SL-U.

In some embodiments, the terminal device 120-1 may be configured to transmit multiple PSBCH transmissions in a S-SSB transmission period (e.g., 160 ms). If the lower layer of the terminal device 120-1 sends a LBT failure indication to the upper layer for a PSBCH transmission among the multiple PSBCH transmissions, the terminal device 120-1 may determine a consistent LBT failure for the PSBCH transmission on associated resource set. In other words, as long as a SL-LBT failure for one PSBCH transmission is detected by the terminal device 120-1, the terminal device 120-1 may determine a consistent LBT failure for the PSBCH transmission on associated resource set.

In some embodiments, if the lower layer sends multiple LBT failure indications to the upper layer for the multiple PSBCH transmissions, the terminal device 120-1 may determine a consistent LBT failure for the PSBCH transmission on associated resource set. In one example, if the terminal device 120-1 detects SL-LBT failures for all PSBCH transmissions in the same S-SSB transmission period, the terminal device 120-1 may determine a consistent LBT failure for the PSBCH transmission on associated resource set.

In some embodiments, if the lower layer sends LBT failure indications to the upper layer for at least a preconfigured percentage of PSBCH transmissions among the multiple PSBCH transmissions, the terminal device 120-1 may determine a consistent LBT failure for the PSBCH transmission on associated resource set. In one example, if the terminal device 120-1 detects SL-LBT failures for a preconfigured percentage of PSBCH transmissions in the same S-SSB transmission period, the terminal device 120-1 may determine a consistent LBT failure for the PSBCH transmission on associated resource set. The preconfigured percentage of PSBCH transmissions may include any percentage (or number) of PSBCH transmissions.

In some embodiments, if the lower layer sends multiple LBT failure indications to the upper layer for multiple PSBCH transmissions associated with a first PSBCH configuration in the S-SSB transmission period on the resource set, the terminal device 120-1 may determine a consistent LBT failure for the PSBCH transmission on associated resource set. In one example, if the terminal device 120-1 detects SL-LBT failures for all legacy PSBCH transmissions (i.e., R16/17 PSBCH transmissions) in the same S-SSB transmission period, the terminal device 120-1 may determine a consistent LBT failure for the PSBCH transmission on associated resource set. In other words, the terminal device 120-1 may only consider the R16/17 PSBCH transmissions when determining a consistent LBT failure for the PSBCH transmission.

In some embodiments, if the lower layer sends multiple LBT failure indications to the upper layer for multiple PSBCH transmissions associated with a second PSBCH configuration in the S-SSB transmission period on the resource set, the terminal device 120-1 may determine a consistent LBT failure for the PSBCH transmission on associated resource set. In one example, if the terminal device 120-1 detects SL-LBT failures for all additional PSBCH transmissions (i.e., R18 PSBCH transmissions) in the same S-SSB transmission period, the terminal device 120-1 may determine a consistent LBT failure for the PSBCH transmission on associated resource set. In other words, the terminal device 120-1 may only consider the additional PSBCH transmissions when determining a consistent LBT failure for the PSBCH transmission.

In some embodiments, if the lower layer sends, to the upper layer, multiple LBT failure indications for multiple PSBCH transmissions associated with the first PSBCH configuration and multiple LBT failure indications for multiple PSBCH transmissions associated with the second PSBCH configuration, the terminal device 120-1 may determine a consistent LBT failure for the PSBCH transmission on associated resource set. In one example, if the terminal device 120-1 detects SL-LBT failures for all legacy PSBCH transmissions and all additional PSBCH transmissions in the same S-SSB transmission period, the terminal device 120-1 may determine a consistent LBT failure for the PSBCH transmission on associated resource set. In other words, the terminal device 120-1 may consider both the legacy PSBCH transmissions and the additional PSBCH transmissions when determining a consistent LBT failure for the PSBCH transmission.

In some embodiments, if the number of LBT failure indications for PSBCH transmissions sent from the lower layer to the upper layer in a period of time is equal to or greater than a predetermined threshold, the terminal device 120-1 may determine a consistent LBT failure for the PSBCH transmission on associated resource set. In one example, if the number of detected SL-LBT failures for PSBCH transmissions reaches a configured threshold in a timer period, the terminal device 120-1 may determine a consistent LBT failure for the PSBCH transmission on associated resource set.

In some embodiments, after determining a consistent LBT failure for PSBCH transmission, the terminal device 120-1 may perform a consistent LBT failure recovery procedure. In some embodiments, the terminal device 120-1 may transmit a report of the consistent LBT failure for at least one PSBCH transmission to the network device 110. The at least one PSBCH transmission may comprise PSBCH transmission considered when determining the consistent LBT failure. In one example, if the terminal device 120-1 is in coverage of the network device 110, the terminal device 120-1 may transmit the report to the network device 110. Alternatively or additionally, if the terminal device 120-1 is out of coverage of the network device 110 for a frequency associated with the resource set and a sidelink configuration is included in a system information block (SIB) or received in RRC signaling, the terminal device 120-1 may transmit the report to the network device 110.

For example, if the terminal device 120-1 is in-coverage or if the terminal device 120-1 is out-of-coverage for the concerned frequency but SL configuration is included in SIB12 or received in dedicate RRC signaling, the terminal device 120-1 may (trigger RRC connection setup/resume if not in RRC CONNECTED mode and) report consistent LBT failure for PSBCH to the network device 110.

In some embodiments, the report may comprise an indication of a configuration associated with the at least one PSBCH transmission. In other words, the terminal device 120-1 may indicate to the network device 110 whether the reported consistent LBT failure is for R16/17 PSBCH transmissions, or for additional PSBCH transmissions.

In some embodiments, after determining a consistent LBT failure for PSBCH transmission, the terminal device 120-1 may perform an autonomous recovery for PSBCH transmission. In one example, if the terminal device 120-1 is out of coverage, the terminal device 120-1 may perform the autonomous recovery for PSBCH transmission.

In some embodiments, multiple resource locations may be configured for the at least one PSBCH transmission. The resource set may be associated with a first resource location among the multiple resource locations. After determining a consistent LBT failure for at least one PSBCH transmission on the resource set, the terminal device 120-1 may switch the at least one PSBCH transmission from the first resource location to a second resource location among the multiple resource locations. In some embodiments, no consistent LBT failure happens on the second resource location.

In some embodiments, the multiple resource locations may comprise multiple frequency locations. For example, multiple configurations, e.g. multiple sl-AbsoluteFrequencySSB, may be introduced for the frequency locations of PSBCH transmission of a specific frequency. When a consistent LBT failure for PSBCH transmission happens at a frequency location sl-AbsoluteFrequencySSB, the terminal device 120-1 may switch to another frequency location sl-AbsoluteFrequencySSB where no consistent LBT failure for PSBCH transmission happens, so as to perform PSBCH transmissions. In other words, the PSBCH transmissions may be transmitted on any of the configured frequency locations sl-AbsoluteFrequencySSB. From reception point of view, when another sidelink terminal device (e.g., the terminal device 120-2, 120-3, 120-4 or other sidelink terminal devices) is to receive potential PSBCH for the specific frequency, the sidelink terminal device may detect possible PSBCH transmissions from the terminal device 120-1 on all configured frequency locations sl-AbsoluteFrequencySSB.

In some embodiments, the multiple resource locations may comprise multiple RB sets. For example, if a SL-BWP includes multiple RB sets, when a consistent LBT failure for PSBCH transmission happens at a RB set, the terminal device 120-1 may switch the PSBCH transmission to another RB set where no consistent LBT failure for PSBCH transmission happens. From reception point of view, when another sidelink terminal device (e.g., the terminal device 120-2, 120-3, 120-4 or other sidelink terminal devices) is to receive potential PSBCH, the sidelink terminal device may detect possible PSBCH transmissions from the terminal device 120-1 on all RB sets in the SL-BWP.

In some embodiments, the multiple resource locations may comprise multiple time allocations. For example, multiple time allocations may be configured for a potential PSBCH transmission. When a consistent LBT failure for PSBCH transmission happens at a time allocation, the terminal device 120-1 may switch to another time allocation where no consistent LBT failure for PSBCH transmission happens, so as to perform PSBCH transmissions. For example, if the terminal device 120-1 is using Timeallocation1 for PSBCH transmission and determines a consistent LBT failure, the terminal device 120-1 may switch to Timeallocation2 or Timeallocation3 if configured and if no consistent LBT failure for PSBCH transmission happens. From reception point of view, when another sidelink terminal device (e.g., the terminal device 120-2, 120-3, 120-4 or other sidelink terminal devices) is to receive potential PSBCH, the sidelink terminal device may detect possible PSBCH transmissions from the terminal device 120-1 on all configured time allocations.

In some embodiments, if consistent LBT failure for PSBCH transmission is determined on all potential resource locations (e.g., absolute frequency location/RB set/time allocation), a sidelink radio link failure may be triggered.

### Example Apparatus

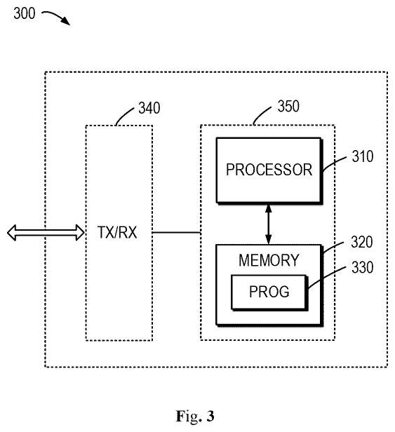

FIG. 3 illustrates a simplified block diagram of a device 300 that is suitable for implementing embodiments of the present disclosure. The device 300 can be considered as a further example implementation of the terminal device 120, and the network device 110 as shown in FIG. 1. Accordingly, the device 300 can be implemented at or as at least a part of the network device 110.

As shown, the device 300 includes a processor 310, a memory 320 coupled to the processor 310, a suitable transmitter (TX) and receiver (RX) 340 coupled to the processor 310, and a communication interface coupled to the TX/RX 340. The memory 310 stores at least a part of a program 330. The TX/RX 340 is for bidirectional communications. The TX/RX 340 has at least one antenna to facilitate communication, though in practice an Access Node mentioned in this disclosure may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 330 is assumed to include program instructions that, when executed by the associated processor 310, enable the device 300 to operate in accordance with the embodiments of the present disclosure, as discussed herein with reference to FIGS. 1-6. The embodiments herein may be implemented by computer software executable by the processor 310 of the device 300, or by hardware, or by a combination of software and hardware. The processor 310 may be configured to implement various embodiments of the present disclosure. Furthermore, a combination of the processor 310 and memory 320 may form processing means 350 adapted to implement various embodiments of the present disclosure.

The memory 320 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 320 is shown in the device 300, there may be several physically distinct memory modules in the device 300. The processor 310 may be of any type suitable to the local technical network, and may include one or more of general purpose computers, special purpose computers, microprocessors, digital signal processors (DSPs) and processors based on multicore processor architecture, as non-limiting examples. The device 300 may have multiple processors, such as an application specific integrated circuit chip that is slaved in time to a clock which synchronizes the main processor.

In some embodiments, an apparatus capable of performing the method 200 (for example, the terminal device 120-1) may comprise means for performing the respective steps of the method 200. The means may be implemented in any suitable form. For example, the means may be implemented in a circuitry or software module. In some embodiments, the means comprises at least one processor and at least one memory including computer program code, the at least one memory and computer program code configured to, with the at least one processor, cause the performance of the method 200.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A terminal device for wireless communication, comprising:
at least one memory; and
at least one processor coupled with the at least one memory and configured to cause the terminal device to:
determine a consistent listen-before-talk (LBT) failure associated with a resource set for sidelink transmissions on unlicensed band; and
perform a consistent LBT failure recovery in response to the consistent LBT failure being determined on the resource set.

2. The terminal device of claim 1, wherein, to determine the consistent LBT failure, the at least one processor is configured to cause the terminal device to:
cause a lower layer of the terminal device to send a LBT failure indication to an upper layer of the terminal device for a sidelink transmission; and
cause the upper layer to increment a number of LBT failure indications sent from the lower layer when the sidelink transmission associated with the LBT failure indication is among the sidelink transmissions on the resource set.

3. The terminal device of claim 1, wherein, to determine the consistent LBT failure, the at least one processor is configured to cause the terminal device to:
cause the lower layer to send a LBT failure indication to an upper layer of the terminal device when a LBT failure for a sidelink transmission among the sidelink transmissions on the resource set is detected by a lower layer of the terminal device; and
cause the upper layer to increment a number of LBT failure indications sent from the lower layer.

4. The terminal device of claim 2, wherein the sidelink transmissions comprise at least one of the following:
a Physical Sidelink Control Channel (PSCCH) transmission, or
a Physical Sidelink Shared Channel (PSSCH) transmission.

5. The terminal device of claim 4, wherein the sidelink transmissions further comprise one of the following:
a Physical Sidelink Feedback Channel (PSFCH) transmission;
a PSFCH transmission based on LBT type 1 for channel access;
a PSFCH transmission in the event that a single PSFCH transmission for a sidelink transmission from another terminal device is enabled;
a Physical Sidelink Broadcast Channel (PSBCH) transmission; and
a PSBCH transmission and a PSFCH transmission.

6. The terminal device of claim 4, wherein, to cause the upper layer to increment the number of LBT failure indications, the at least one processor is configured to cause the terminal device to:
when a plurality of PSFCH transmissions for a sidelink transmission from another terminal device are enabled, cause the upper layer to increment the number of LBT failure indications by one based on one of the following:
the sidelink transmission associated with the LBT failure indication being a last PSFCH transmission among the plurality of PSFCH transmissions, and
the lower layer sending a plurality of LBT failure indications to the upper layer for the plurality of PSFCH transmissions.

7. The terminal device of claim 4, wherein, to cause the lower layer to send the LBT failure indication to the upper layer, the at least one processor is configured to cause the terminal device to:
when a plurality of PSFCH transmissions for a sidelink transmission from another terminal device are enabled, cause the lower layer to send the LBT failure indication to the upper layer based on one of the following:
the sidelink transmission associated with the LBT failure is a last PSFCH transmission among the plurality of PSFCH transmissions, and
a plurality of LBT failure for the plurality of PSFCH transmissions are detected by the lower layer.

8. The terminal device of claim 2, wherein the sidelink transmissions comprise:
a sidelink transmission based on LBT type 1 for channel access.

9. The terminal device of claim 2, wherein the LBT failure indications comprise an indication associated with the resource set, and wherein the resource set comprises one of the following:
at least one resource block (RB) set;
at least one resource pool; and
at least one sidelink bandwidth part.

10. The terminal device of claim 1, wherein the at least one processor is configured to determine the consistent LBT failure based on one of the following:
a lower layer of the terminal device sending, to an upper layer of the terminal device, a LBT failure indication for a PSBCH transmission among a plurality of PSBCH transmissions in a sidelink synchronization signal block (S-SSB) transmission period on the resource set;
the lower layer sending, to the upper layer, a plurality of LBT failure indications for the plurality of PSBCH transmissions;
the lower layer sending, to the upper layer, LBT failure indications for at least a preconfigured percentage of PSBCH transmissions among the plurality of PSBCH transmissions;
the lower layer sending, to the upper layer, a plurality of LBT failure indications for a first plurality of PSBCH transmissions associated with a first PSBCH configuration in the S-SSB transmission period on the resource set;
the lower layer sending, to the upper layer, a plurality of LBT failure indications for a second plurality of PSBCH transmissions associated with a second PSBCH configuration in the S-SSB transmission period on the resource set;
the lower layer sending, to the upper layer, a plurality of LBT failure indications for the first plurality of PSBCH transmissions and a plurality of LBT failure indications for the second plurality of PSBCH transmissions; and
the number of LBT failure indications for PSBCH transmissions sent from the lower layer to the upper layer in a period of time being equal to or greater than a predetermined threshold.

11. The terminal device of claim 10, wherein, to perform the consistent LBT failure recovery, the at least one processor is configured to cause the terminal device to:
transmit a report of the consistent LBT failure for at least one PSBCH transmission to a network device.

12. The terminal device of claim 11, wherein the report is transmitted to the network device based on at least one of the following:
the terminal device being in coverage of the network device; or
the terminal device being out of coverage of the network device for a frequency associated with the resource set and a sidelink configuration being included in a system information block or received in Radio Resource Control (RRC) signaling.

13. The terminal device of claim 12, wherein the report comprises an indication of a configuration associated with the at least one PSBCH transmission.

14. The terminal device of claim 10, wherein, to perform the consistent LBT failure recovery, the at least one processor is configured to cause the terminal device to:
perform an autonomous recovery for at least one PSBCH transmission.

15. The terminal device of claim 14, wherein, to perform the autonomous recovery, the at least one processor is configured to case the terminal device to perform the autonomous recovery when the terminal device is out of coverage of a network device.

16. The terminal device of claim 14, wherein a plurality of resource locations are configured for the at least one PSBCH transmission, the resource set is associated with a first resource location among the plurality of resource locations, and wherein, to perform the autonomous recovery, the at least one processor is configured to cause the terminal device to:
switch the at least one PSBCH transmission from the first resource location to a second resource location among the plurality of resource locations.

17. The terminal device of claim 16, wherein no consistent LBT failure happens on the second resource location.

18. The terminal device of claim 16, wherein the plurality of resource locations comprises one of the following:
a plurality of frequency locations;
a plurality of RB sets; and
a plurality of time allocations.

19. A method performed by a terminal device, the method comprising:
determining a consistent listen-before-talk (LBT) failure associated with a resource set for sidelink transmissions on unlicensed band; and
performing a consistent LBT failure recovery in response to the consistent LBT failure being determined on the resource set.

20. A non-transitory computer readable medium having program instructions stored thereon that, when executed by an apparatus, cause the apparatus at least to:
determine a consistent listen-before-talk (LBT) failure associated with a resource set for sidelink transmissions on unlicensed band; and
perform a consistent LBT failure recovery in response to the consistent LBT failure being determined on the resource set.
